(19) United States
(12) Patent Application Publication
(10) Pub. No.: US 2005/0273394 A1
(43) Pub. Date: Dec. 8, 2005

(54) Method and system for providing enhanced online support

(75) Inventor: Arno Schonhals, Wendelstein (DE)

Correspondence Address: BAKER BOTTS L.L.P.;PATENT DEPARTMENT, 98 SAN JACINTO BLVD., SUITE 1500, AUSTIN, TX, 78701-4039, US

(73) Assignee: Siemens Aktiengesellschaft

(21) Appl. No.: 10/862,484

(22) Filed: Jun. 7, 2004

(51) Int. Cl. G06F 17/60

(52) U.S. Cl. 705/26

(57) ABSTRACT

A method for providing customer online support by a manufacturer or distributor comprises the steps of during engineering or customizing of a product, generating product specific information and storing the product specific information in a file, transferring the file through the Internet to the manufacturer or distributor, assigning the file to a customer and storing the file in a customer database, and using the file for prioritizing a search result provided by the customer online support by means of searching a support database.

### TECHNICAL FIELD OF THE INVENTION

The present relates to a method and system for providing enhanced online support via an Internet support webpage.

### BACKGROUND OF THE INVENTION

Today, product support, in particular for highly technical devices, is provided via the Internet. Manufacturers of such products dedicate specific support webpages for their customers to allow them to identity and solve specific problems with purchased products. One of the most known and commonly used type of webpages are, for example, software support pages which allow a customer or user to download the latest drivers necessary to properly run their applications, etc. In case of malfunctioning, often help webpages including sections like “frequently asked questions” are provided. Furthermore, many manufacturers include search engines which provide the customers or users with a plurality and wide variety of information about their products. Such support is particularly important for manufacturers of automation systems and other highly technical products for which after sale support is an important part of the offered service. Such support webpages usually provide their information in form of a tree structure including a plurality of branches that lead to different parts of information related to different products and/or different aspects of a respective product. Through search engines a user can request information about a relevant problem to be solved. However, due to the complex structure of such databases, this can lead to an overwhelming result of information including often non-relevant data. The user has to filter this information and is often confronted with selecting the right from the wrong information. The more complicated a particular product, the more information about the product is available. A user then often faces search results which are overloaded and not precise.

### SUMMARY OF THE INVENTION

One advantage of the present application is to provide a method for providing a support webpage with an enhanced service that provides for a more efficient support of highly technical products.

An exemplary method for providing customer online support by a manufacturer or distributor comprises the steps of during engineering or customizing of a product, generating product specific information and storing the product specific information in a file, transferring the file through the Internet to the manufacturer or distributor, assigning the file to a customer and storing the file in a customer database, and using the file for prioritizing a search result provided by the customer online support by means of searching a support database.

The product can be an automation system. The step of generating product specific information can be performed automatically or manually during the engineering phase. The product specific information may include information about used engineering tools including information about the respective versions, used devices, modules, and/or busses including their respective release dates, a structure of the product, a network used in the product, used software and or firmware including their respective versions, project specific parameter, and/or used system functions and/or subroutines. The prioritization can be performed by listing the search result in order from highest to lowest priority. The provided search results may include information about the respective priority of each individual result. The prioritization can be performed by listing the search result showing only results with a predefined minimum priority level. The support database may have a tree structure.

Another exemplary method for providing customer online support by a manufacturer or distributor comprises the steps of during engineering or customizing of a product, generating product specific information and storing the product specific information in a file, transferring the file through the Internet to the manufacturer or distributor, assigning the file to a customer and storing the file in a customer database, and using the file for prioritizing a navigation through a tree-structured database provided by the customer online support.

Again, the product can be an automation system. The step of generating product specific information can be performed automatically or manually during the engineering phase. The product specific information may include information selected from the group consisting of: used engineering tools including information about the respective versions; used devices, modules, and/or busses including their respective release dates; a structure of the product; a network used in the product; used software and or firmware including their respective versions; project specific parameter; and used system functions and/or subroutines. The database can be a tree structured database and the prioritization can be performed by determining the priority of each branch of the tree structured database and displaying the tree structure wherein branches of the tree structure are highlighted according to their priority. The database can be a tree structured database and the prioritization can be performed by determining the priority of each branch of the tree structured database and displaying only those branches of the tree structure having a priority above a predefined threshold.

An exemplary embodiment comprises an internet server for providing customer online support by a manufacturer or distributor comprising a customer database for storing a plurality of customer project files, a support database, and a search engine, wherein the search engine searches the support database according to a customer request and accesses the customer database to prioritize a search result using data which is stored in a project file which is assigned to the customer.

The project file may include information selected from the group consisting of: used engineering tools including information about the respective versions; used devices, modules, and/or busses including their respective release dates; a structure of the product; a network used in the product; used software and or firmware including their respective versions; project specific parameter; and used system functions and/or subroutines.

An exemplary method for providing information for customer by a manufacturer or distributor comprising the steps of during engineering or customizing of a product, generating product specific information and storing the product specific information in a file, transferring the file through the Internet to the manufacturer or distributor, assigning the file to a customer and storing the file in a customer database, and using the file for providing individualized information for the customer based on the file.

Again, the product can be an automation system. The step of generating product specific information can be performed automatically or manually during the engineering phase. The step of generating product specific information is performed manually during the engineering. The product specific information may include information selected from the group consisting of: used engineering tools including information about the respective versions; used devices, modules, and/or busses including their respective release dates; a structure of the product; a network used in the product; used software and or firmware including their respective versions; project specific parameter; and used system functions and/or subroutines. The information may include information about updates and/or upgrades. The information may include information about a phasing out of a product.

Other technical advantages of the present disclosure will be readily apparent to one skilled in the art from the following figures, descriptions, and claims. Various embodiments of the present application obtain only a subset of the advantages set forth. No one advantage is critical to the embodiments.

### BRIEF DESCRIPTION OF THE DRAWINGS

A more complete understanding of the present disclosure and advantages thereof may be acquired by referring to the following description taken in conjunction with the accompanying drawings, in which like reference numbers indicate like features, and wherein:

FIG. 1 is flow chart of typical steps during planning and operation of a product;

FIG. 2 is steps typically executed in an automation process;

FIG. 3 shows a block diagram of a system using the method according to the present application;

FIG. 4 is an exemplary tree structure of a database;

FIG. 5 shows highlighted results of an exemplary search performed according to a support search with a method according to the prior art; and

FIG. 6 shows highlighted results of an exemplary search performed according to a support search with a method according to the present application;

### DETAILED DESCRIPTION OF THE PREFERRED EMBODIMENTS

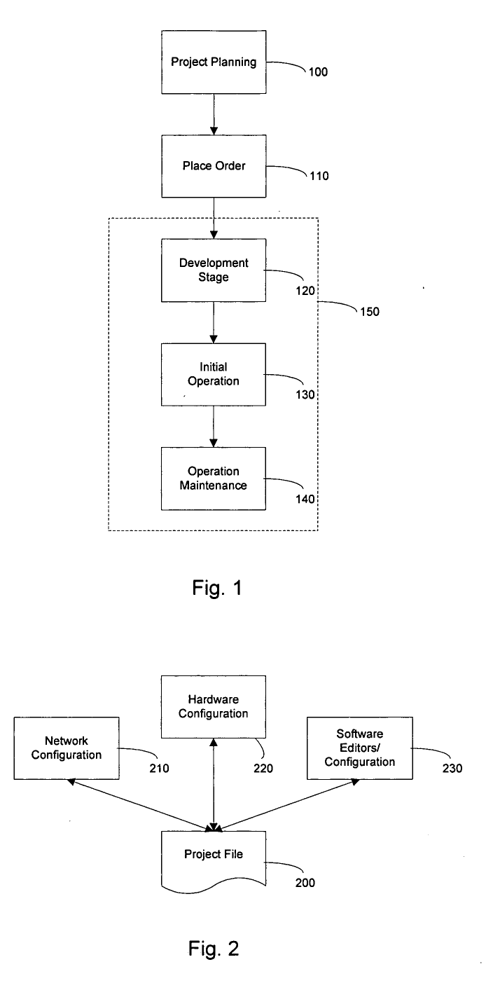

Turning to the drawings, exemplary embodiments of the present application will now be described. FIG. 1 depicts typical steps during the planning, installation, and operation of a complex automation system. Step 100 designates a planning phase of a new project. With step 110 follows the actual order of the system from a manufacturer. During the subsequent phase 150, different types of information from the manufacturer might be required. This phase 150 is, thus, called the after sales phase. Usually, this phase 150 may consist of a development phase 120, a initialization or taking into operation phase 130, and an operating and maintenance phase 140. During any of these steps 120-140 external information and data might be required to guarantee a proper function of the system. To this end, in most cases, the user request this information online through the Internet without any life support from the manufacturers personnel.

In prior art systems, this support is provided by online support webpages which retrieve the necessary information and data from a complex database maintained by the manufacturer. The user has to either navigate through a tree-structured database or request the information by more or less sophisticated search engines. These databases are usually organized by specific topics or key words. In case of complex structures the user easily loses overview over the tree-structured databases and gets overwhelmed by the amount of data resulting from a key word search. To improve these types of databases, the manufacturers try to improve the logic of the search engines by using so-called topic maps and/or taxonomies, by means of which information and contributing articles are linked together. Furthermore, the web based support engine can monitor and protocol the behavior of a user to learn what the respective user is looking for and improve and optimize future requests. However, all these measurements are either inefficient or require too much effort to provide useful results.

According to different embodiments of the present application, a more efficient and accurate web based after sales support can be provided through the Internet. FIG. 2 shows exemplary steps during the set up of a complex automation system. A user typically relies on different engineering tools to set up a new automation system and does various project and parameter determination/activities. Thus, a variety of different data is generated during such a set up or engineering phase. These data are then usually stored on the development system in form of a project file. For example, a network configuration 210 might require the set up of a network topology between respective components of the system. Furthermore, a hardware configuration 220 may require the configuration of used devices whether they are implemented locally or external. Also, the automation software configuration 230 requires the proper set up of parameters, such as measurement ranges, data transfer speeds and types, etc., as well as the actual configuration of the automation software using the available instructions, subroutines, and system functions which are available and provided by the respective system. All data generated during these steps can then be stored in a respective project file 200 on the engineering system. Such a project file is not necessarily a single file. Depending on the engineering system, it can be a single file, a plurality of files, or a database system. Thus, such a file or database may contain a plurality of information and data about the respective system, such as:
used engineering tools including information about the respective versions,
used devices, modules, busses including their respective release dates,
structure of the system and the network if used, including information about centralized, decentralized, and sub-network structure,
specific information about users connected to a bus or network, memory requirements of the application software, etc.,
project specific parameter of any kind; such as data transfer speeds and protocols, measurement information, etc.,
used system functions, subroutines, etc.

In advantageous embodiments of the present application, these data generated during the engineering phase of an automation system can be stored in a project content description file and later used to improve the production of available information during an online support via the Internet. Basically, such a file can store the products and their respective configuration of a respective project. Generating these data is not restricted to the engineering phase proper, such as step 120 as shown in FIG. 1. It can also encompass steps 100 and 110 during which additional information might be available and/or generated.

Furthermore, the engineering tools which are provided by the manufacturer can sort and filter the generated data and tailor them specifically to the needs of the respective search engine as will be explained in more detail below. For example, the system can provide each data which will be useful for the search engine with a respective weight depending on the respective interaction of a component or parameter and depending on its importance, thus, creating certain priorities for specific elements/components and parameters of the system. For example, certain modules and/or components might have a more or less higher influence on the proper function of a specific other component or module, for example, a drive, a hydraulic or pneumatic sub-component, etc. The system may use a specifically designed internal database to determine such a relationship and to generate additional data which can be used by the search engine in a later support request. Furthermore, such an interrelationship can either be generated automatically or manually during the engineering of the system. For example, the user could extract or export the project content description file from the engineering system or alternatively, a special tool within the engineering system could be provided which will offer this function to the user. Thus, certain key functions of a system can be extracted and respective data identifying those functions can be generated and stored in a specific project content description file. In a less sophisticated system, only the key data about the respective automation system, such as all components, modules, and their interconnection, as well as used software, etc are stored in such a project content description file. Thus, the project content description file could have preprocessed data including weighting or pure description data or anything in between.

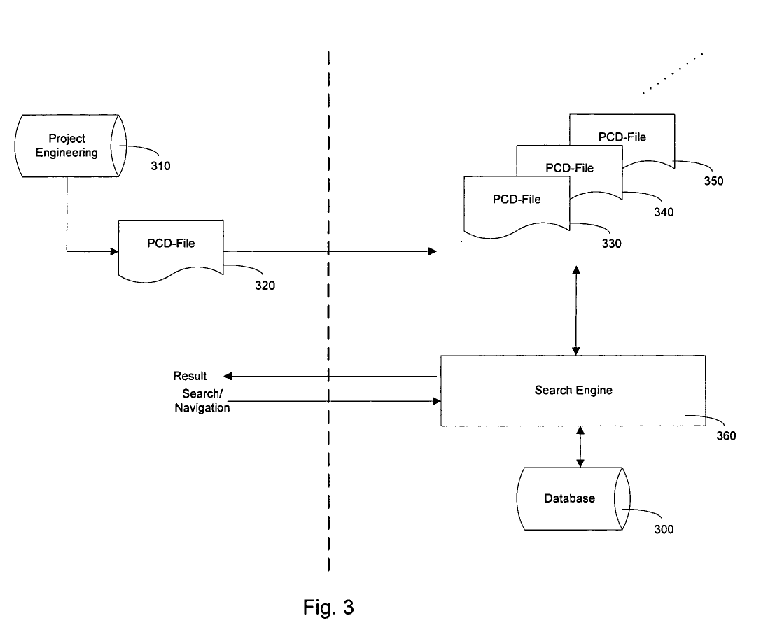

FIG. 3 shows how such a generated project content description file will be used. The project content description file 320 which has been generated during the product or project engineering phase 310 is transferred to the manufacturer and can be stored in a customer database. This customer database may comprise a plurality of customer specific project content description files 330 . . . 350 for different customers and/or different automation systems. Whenever, the user now requests additional support through the webpage through a search or through navigation, the search engine 360 first retrieves this previously stored data file 310, 330 . . . 350 and uses it to further filter the data retrieved from the database 300 which would normally generate a much bigger search result. The user can store a respective project content description file during a registration procedure. Alternatively, the project content description file can be manually or automatically requested by the search engine during a first or initial support session. Also alternatively, such a file could be transferred every time the user requests support from the support webpage. In other exemplary embodiments, updates of the project content description file can be automatically or manually requested by the search engine or could be transferred with each access. Thus, the project content description file would be permanently kept up to date.

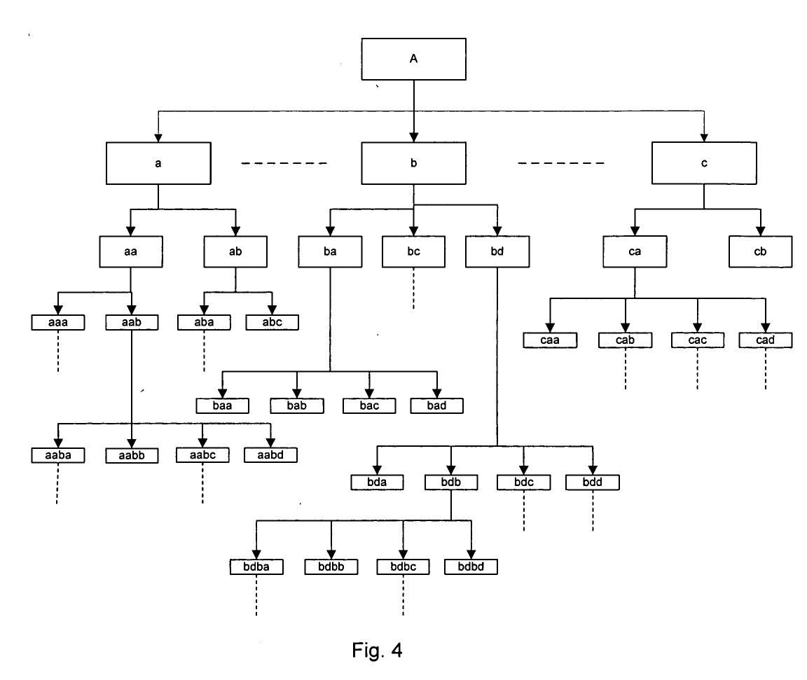

The search engine uses this data file to determine the relevance of the retrieved data and personalize these results according to the user's system. FIG. 4 shows a simplified exemplary tree structure of a database having a plurality of different information files. Each information box either designates an information file cb, abc, caa, baa, bab, bac, bad, bda, aabb, aabd, bdbb, bdbd or a node or information file a, b, c, aa, ab, ac, . . . from which more nodes or information files can be accessed. Thus, in this exemplary tree structure, dotted lines indicate that more branches and nodes are available and boxes with no further connection indicate a final resulting information file.

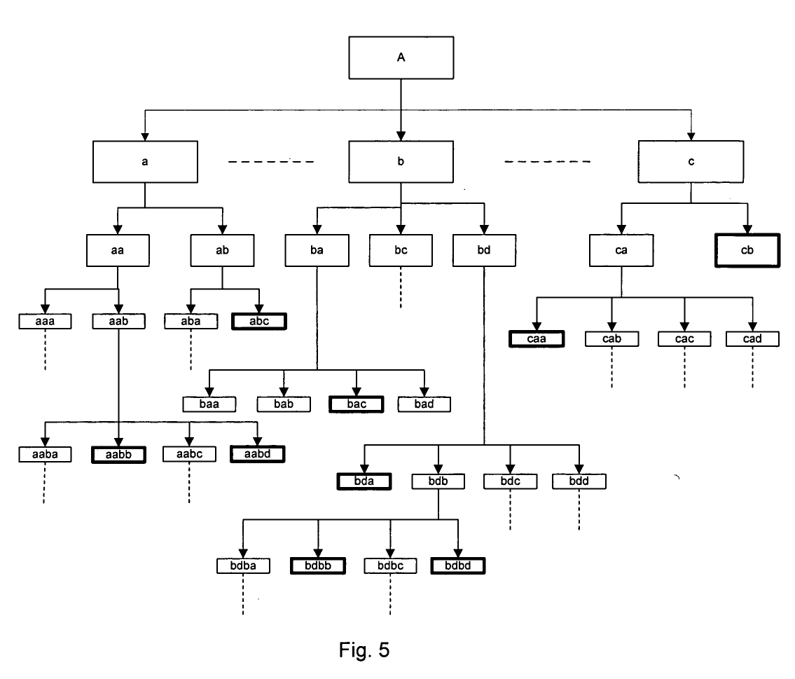

A user either request additional information during a support session from the Internet through a search engine or by means of a guided or unguided navigation through the tree structured database. FIG. 5 shows an exemplary result of such a search with a search engine according to the prior art. The bold outlined boxes cb, abc, caa, bac, bda, aabb, aabd, bdbb, bdbd are assumed to be possible results of such a search. Thus, a search would result in a list of documents provided by the respective information files cb, abc, caa, bac, bda, aabb, aabd, bdbb, bdbd. However, further assuming that, for example, only information file bda contains relevant information for the user's specifically designed system, the user could be overwhelmed with irrelevant data and might not be able to find the important file bda which could solve his current problem.

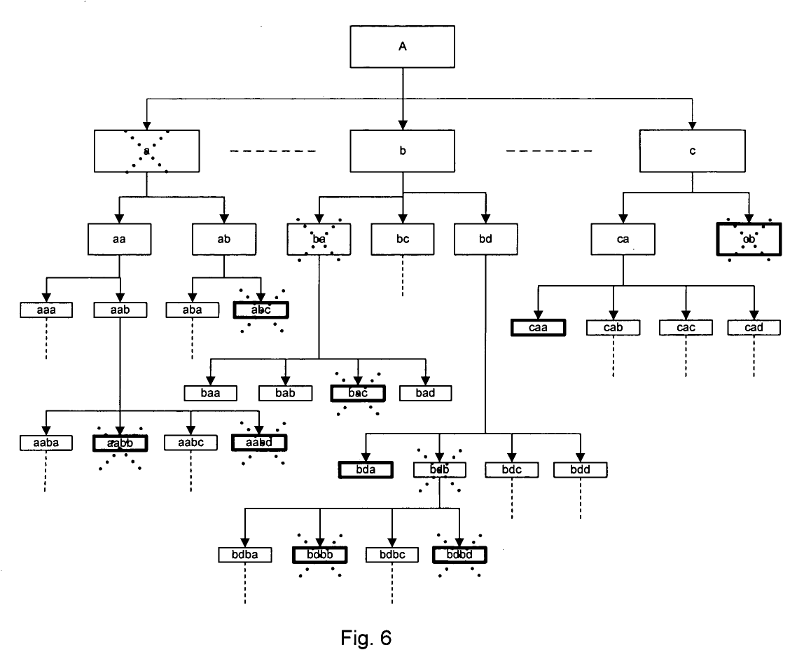

FIG. 6 shows the effect of a search engine which provides for a filter function by means of the previously generated project content description file. Because the search engine is provided with information about the user's system it can filter out certain files, nodes or entire branches of the tree structured database. This procedure is, for example, indicated by the strike out symbols which in this exemplary embodiment would delete the entire branch following node a, the sub-branches ba and bdb and the information file cb. Thus, many irrelevant information files would not be presented to the user and in this case, the result would be reduced, for example, to two information files caa and bda including the assumed highly relevant information file bda.

In another embodiment, the strike out symbol stands for a particular weighting function. The strike out symbol can, thus, provide the following tree or the specific information file with a predefined priority weight. In this example, the strike out would lower the priority of the affected information files and branches. Again, the system can display all results from a search by showing the results in order of highest priority. Alternatively, a minimum threshold priority could be predetermined and used to filter out irrelevant results. In yet another embodiment, positive priority weighting could be used to set higher priorities, for example, those information files which have been determined to be of the most relevance.

A similar result would be generated in a guided or unguided navigation through the tree-structured database. In such a navigation process, certain branches and nodes would be filtered out, thus, simplifying the available routes through the database and allowing the user to quickly retrieve the most relevant information files depending on his previously submitted project content description file. In case, the support webpage actually graphically shows the tree structure of the database, the system could highlight the most relevant branches which would lead to the most relevant information files. Different types of highlighting could be used according to the determined priorities.

In yet another embodiment, the same results as shown in FIG. 5 could be presented, however, the result could be presented in a specific order showing the most relevant information files first by using the above described method of weighting the specific results. Thus, in the unlikely case of a mismatch, the user would still have access to all data generated by the search engine.

The different embodiments of the present application are not restricted to tree-structured databases but can easily be applied to other types of databases. In most cases, a user will not know what type of database supports the respective support webpage. For the user such a system offers highly improved results and prevents frustration of a user. Showing additionally the priority of the respective results.

Assuming a user wants to know whether new software updates are available from the manufacturer. The user will then access the support webpage and identify himself, for example, with a designated user name and password. Then, the user will either search for new updates, for example, with a search request “Firmware Updates for S7” or access a designated update webpage. The system will respond by searching the respective database as previously disclosed with respect to FIGS. 4-6. Because the search engine is now provided with a list of all modules and components and their respective software driver version through the previously transmitted user's project content description file, it will only display those software drivers which are necessary for this specific user or show all drivers which are necessary first in a list, for example, highlighted.

The project content description files stored in manufacturer's designated database can furthermore be used to provide the customers with personalized/individualized newsletter that contains only information that is relevant for that specific customer and his system. This can be in particular helpful for customers that maintain and operate a plurality of systems. For example, such a newsletter could contain information about future releases, necessary updates or debugging, or product phase out information which relate to one or more systems of this customer.

Another advantage of the disclosed embodiments lies in the fact that no additional registration procedure with the requirement of providing all the necessary information is necessary because all the necessary information can be retrieved during the engineering phase with very little or no additional effort. This also prevents human error in providing this information and, thus, a higher quality of the transmitted data. Furthermore, the automatic generation of a project content description file can be very detailed and include information that is usually not accessible for the customer. By providing the necessary support through the Internet, the system can immediately update the respective project content description file, for example, by replacing the version information of downloaded firmware or software or of additionally ordered system components.

The various embodiments described above are also not restricted to be used by manufacturers but can also be provided by any type of distributor or agent who sell complex systems which require intensive after sale support. Also the embodiments are not restricted to the after sale support of automation systems and can be used with respect to any complex system or product.

1. A method for providing customer online support by a manufacturer or distributor comprising the steps of:
during engineering or customizing of a product, generating product specific information and storing said product specific information in a file;
transferring said file through the Internet to the manufacturer or distributor;
assigning said file to a customer and storing said file in a customer database;
using said file for prioritizing a search result provided by said customer online support by means of searching a support database.

2. The method as claimed in claim 1, wherein the product is an automation system.

3. The method as claimed in claim 1, wherein the step of generating product specific information is performed automatically during the engineering.

4. The method as claimed in claim 1, wherein the step of generating product specific information is performed manually during the engineering.

5. The method as claimed in claim 1, wherein the product specific information includes information about used engineering tools including information about the respective versions.

6. The method as claimed in claim 1, wherein the product specific information includes information about used devices, modules, and/or busses including their respective release dates.

7. The method as claimed in claim 1, wherein the product specific information includes information about a structure of the product.

8. The method as claimed in claim 1, wherein the product specific information includes information about a network used in said product.

9. The method as claimed in claim 1, wherein the product specific information includes information about used software and or firmware including their respective versions.

10. The method as claimed in claim 1, wherein the product specific information includes information about project specific parameter.

11. The method as claimed in claim 1, wherein the product specific information includes information about used system functions and/or subroutines.

12. The method as claimed in claim 1, wherein the prioritization is performed by listing the search result in order from highest to lowest priority.

13. The method as claimed in claim 12, wherein the provided search results includes information about the respective priority of each individual result.

14. The method as claimed in claim 1, wherein the prioritization is performed by listing the search result showing only results with a predefined minimum priority level.

15. The method as claimed in claim 1, wherein the support database has a tree structure.

16. A method for providing customer online support by a manufacturer or distributor comprising the steps of:
during engineering or customizing of a product, generating product specific information and storing said product specific information in a file;
transferring said file through the Internet to the manufacturer or distributor;
assigning said file to a customer and storing said file in a customer database;
using said file for prioritizing a navigation through a tree-structured database provided by said customer online support.

17. The method as claimed in claim 16, wherein the product is an automation system.

18. The method as claimed in claim 16, wherein the step of generating product specific information is performed automatically during the engineering.

19. The method as claimed in claim 16, wherein the step of generating product specific information is performed manually during the engineering.

20. The method as claimed in claim 16, wherein the product specific information includes information selected from the group consisting of: used engineering tools including information about the respective versions; used devices, modules, and/or busses including their respective release dates; a structure of the product; a network used in said product; used software and or firmware including their respective versions; project specific parameter; and used system functions and/or subroutines.

21. The method as claimed in claim 16, wherein the database is a tree structured database and the prioritization is performed by determining the priority of each branch of the tree structured database and displaying said tree structure wherein branches of said tree structure are highlighted according to their priority.

22. The method as claimed in claim 21, wherein the database is a tree structured database and the prioritization is performed by determining the priority of each branch of the tree structured database and displaying only those branches of said tree structure having a priority above a predefined threshold.

23. An Internet server for providing customer online support by a manufacturer or distributor comprising:
a customer database for storing a plurality of customer project files;
a support database;
a search engine, wherein the search engine searches the support database according to a customer request and accesses the customer database to prioritize a search result using data which is stored in a project file which is assigned to said customer.

24. The server as claimed in claim 16, wherein the project file includes information selected from the group consisting of: used engineering tools including information about the respective versions; used devices, modules, and/or busses including their respective release dates; a structure of the product; a network used in said product; used software and or firmware including their respective versions; project specific parameter; and used system functions and/or subroutines.

25. A method for providing information for customer by a manufacturer or distributor comprising the steps of:
during engineering or customizing of a product, generating product specific information and storing said product specific information in a file;
transferring said file through the Internet to the manufacturer or distributor;
assigning said file to a customer and storing said file in a customer database;
using said file for providing individualized information for said customer based on said file.

26. The method as claimed in claim 25, wherein the product is an automation system.

27. The method as claimed in claim 25, wherein the step of generating product specific information is performed automatically during the engineering.

28. The method as claimed in claim 25, wherein the step of generating product specific information is performed manually during the engineering.

29. The method as claimed in claim 25, wherein the product specific information includes information selected from the group consisting of: used engineering tools including information about the respective versions; used devices, modules, and/or busses including their respective release dates; a structure of the product; a network used in said product; used software and or firmware including their respective versions; project specific parameter; and used system functions and/or subroutines.

30. The method as claimed in claim 16, wherein the information includes information about updates and/or upgrades.

31. The method as claimed in claim 16, wherein the information includes information about a phasing out of a product.
